(19) United States
(12) Patent Application Publication
(10) Pub. No.: US 2015/0188469 A1
(43) Pub. Date: Jul. 2, 2015

(54) METHOD AND SYSTEM FOR CONTROLLING THE PROGRESSIVE CHARGING OF AN ALTERNATOR OF A MOTOR VEHICLE, AND MOTOR VEHICLE ALTERNATOR COMPRISING SUCH A SYSTEM

(71) Applicant: VALEO EQUIPEMENTS ELECTRIQUES MOTEUR, Creteil Cedex (FR)

(72) Inventors: Pierre Tisserand, Limeil Brevannes (FR); Pierre Chassard, Creteil (FR)

(21) Appl. No.: 14/415,451

(22) PCT Filed: Jul. 31, 2013
(86) PCT No.: PCT/FR2013/051846

§ 371 Date: Jan. 16, 2015

(30) Foreign Application Priority Data
Aug. 28, 2012 (FR) 1258017

(51) Int. Cl. H02P 9/02; B60R 16/03

(52) U.S. Cl. CPC H02P 9/02; B60R 16/03; H02P 2101/45

(57) ABSTRACT

A method carried out in an alternator supplying a supply voltage slaved to a nominal value by means of a control loop controlling an excitation current of the alternator via a pulse width modulation of the current. The method limits the power draw by the alternator from the heat engine of the vehicle in a progressive response phase (LRC_Ph) with a higher supply voltage drop to a pre-determined triggering threshold by only authorizing progressive increases of a current cyclic ratio (DC_EXC) of the excitation current from an initial cyclic ratio (DC_I) to an expected cyclic ratio calculated by the control loop. According to the invention, at the beginning of the progressive response phase, the initial cyclic ratio is increased by a pre-determined jump only if the regulation loop does not have an acyclism.

### TECHNICAL FIELD OF THE INVENTION

The present invention relates to a method for controlling the progressive charging of an alternator which is designed to be coupled to a thermal engine of a motor vehicle. The invention also relates to a system which can implement this method, as well as to the alternator comprising this system.

### TECHNOLOGICAL BACKGROUND OF THE INVENTION

In the automobile industry, it is well known to maintain a voltage which is supplied to the on-board electrical network by an alternator of the vehicle at a predetermined set value, independently from the speed of rotation of the engine or the electrical consumption of the equipment, by means of a regulation device known as a regulator.

This regulator, which is generally integrated in the alternator, controls an excitation current which is supplied by a battery, and circulates in an excitation winding of the alternator.

Nowadays, motor vehicle parts manufacturers have developed very high-performance alternators by implementing electronic power systems controlled by circuits which use digital techniques, based in particular on the use of microprocessors or microcontrollers.

These techniques permit far better stabilisation of the voltage of the on-board network than the previous thermal switches, in response to the activation of substantial electric charges in the vehicle.

However, it can be understood that a demand for increase of the excitation current by the regulation system must not lead to a rapid increase in the torque collected by the alternator from the thermal engine, as this is liable to make the thermal engine stall, in particular when it is running at idling speed, or is cold when the vehicle is started.

It is therefore known to limit the resistant torque collected by an alternator by means of a progressive charging function known as LRC (acronym for Load Response Control), provided by a circuit of the type disclosed in the European patent application EP0611215.

Control of the intensity of the excitation current is generally obtained by means of variation of the duty cycle of an excitation signal of the PWM (Pulse Width Modulation) type by controlling a power switch of the excitation circuit.

In a known manner, and further to detection of a charging requirement, the LRC function permits only progressive increases of the duty cycle of the excitation signal from the initial value, up to the value determined by the regulation loop.

A known disadvantage of this LRC function is that it “cramps” the regulation loop, the negative consequences of which become apparent when periodic charges are connected. For example, activation of the emergency lights of the vehicle can give rise to variation of the intensity of the headlights.

Technical solutions which use an intermediate signal known as “progressive charging return” make it possible to eliminate this disadvantage by controlling the incrementation of the initial value up to the limit of a maximum value permitted by the duty cycle, as in the method disclosed in French patent application FR2944658.

Also in a known manner, as disclosed in French patent application FR2933549, the duty cycle is increased by a predetermined duty cycle jump (Dead Band, Dead Spot, Dead Zone or Alpha Factor), for example of 10%, in order to provide a minimum excitation current at the moment of the charging requirement.

The excitation signal which effectively controls the excitation circuit is derived from the multiplexing of the excitation demand signal generated by the regulation loop, and by the excitation signal produced by the LRC function, under the control of the LRC function.

However, the above-described type of LRC function has the disadvantage that it is not suitable for implementation in alternators coupled to thermal engines which can run at low idling speeds of approximately 800 rpm or even 680 rpm.

In fact, at these idling speeds, which are selected by certain vehicle manufacturers for reasons of energy-saving, the curve of outgoing current/speed of rotation of a standard alternator has a strong gradient.

As a result, a small variation of the charge of the alternator gives rise to a large variation of the voltage applied to the battery, which is taken into account by the control loop of the regulator. The regulator then varies the duty cycle of the excitation up to the maximum (from 0 to 100%) without being able to compensate, since the frequencies of the acyclism (20-30 Hz) are generally beyond the pass band of the regulator (15 Hz).

In these conditions, it appears that this type of LRC function is disrupted, since the progressive charging return signal always follows the current value of the duty cycle, which tends to oscillate at the frequency of the acyclism.

As a result, the duty cycle of the excitation signal produced by the LRC function is always close to 100%.

Analysis of the situation by the inventive body has shown that the predetermined duty cycle jump, which is applied at each triggering of the LRC to voltage variations caused by the acyclism, has the effect of bringing the duty cycle rapidly up to the peak excitation values: the LRC function becomes “almost without effect”.

### GENERAL DESCRIPTION OF THE INVENTION

The object of the present invention is thus to eliminate this weakness.

Specifically, its subject is a method for controlling the progressive charging of an alternator of a motor vehicle which is designed to be coupled to a thermal engine of the vehicle.

In a known manner, an alternator of this type can produce a supply voltage of an on-board network of the vehicle which depends on a set value, by means of a regulation loop which controls an excitation signal of the variable pulse width type, which controls an excitation current circulating in an excitation winding of the alternator.

The method in question consists more specifically of limiting collection of torque by the alternator from the thermal engine in a phase of progressive response to a supply voltage drop which is greater than a predetermined triggering threshold, and permitting only progressive increases of a current duty cycle of the excitation signal, from an initial duty cycle up to an expected duty cycle calculated by the regulation loop.

The method according to the invention is distinguished in that, at the beginning of the progressive response phase, the initial duty cycle is increased by a predetermined duty cycle jump only if the regulation loop does not have an acyclism.

Advantage is derived from the fact that, in the method for controlling the progressive charging of an alternator of a motor vehicle according to the invention, the initial duty cycle does not drift towards a full field in the case of acyclism, and the initial duty cycle is reset at the end of the acyclism substantially to a mean value of this acyclism.

Highly advantageously, in this method, during the progressive response phase, the current duty cycle is equal to a progressive charging control duty cycle which increases linearly during at the most a predetermined rising time, and, at the end of this progressive response phase, the current duty cycle is equal to the expected duty cycle, and a progressive charging return signal which controls the initial duty cycle decreases linearly during at most a predetermined descent time, during a progressive response return phase.

Presence of the acyclism is preferably determined by simultaneous creation of the following conditions in the progressive response return phase:
the supply voltage drop is greater than the predetermined triggering threshold;
the expected duty cycle is greater than the progressive charging return signal.

At the end of the progressive response return phase, during a phase of alignment with the expected duty cycle, highly advantageously the progressive charging return signal increases linearly during a first continuation time, or it decreases linearly during a second continuation time.

Preferably, the first and second continuation times are equal.

In the method for controlling the progressive charging of an alternator of a motor vehicle according to the invention, the initial duty cycle is advantageously reset to a predetermined starting value when a speed of rotation of the alternator becomes higher than a predetermined starting speed, starting from a stoppage.

The invention also relates to a system for controlling the progressive charging of an alternator of a motor vehicle which can implement the above-described method.

According to a known architecture, this alternator is designed to be coupled to a thermal engine of the vehicle, and comprises a regulation loop which subjects a supply voltage of an on-board network of the vehicle to a set value by controlling an excitation signal of the variable pulse width type, which controls an excitation current circulating in an excitation winding of the alternator.

More specifically, the system in question is of the type comprising a numerical processing unit, comprising a first module for detection of a charging requirement starting from an expected duty cycle, a second module for determination of an initial duty cycle, and a third module for controlling the progressive charging comprising a counter/down-counter which provides an index corresponding either to a progressive charging control duty cycle which increases progressively starting from the initial duty cycle, or to a progressive charging return signal.

The system for controlling the progressive charging of an alternator of a motor vehicle according to the invention is distinguished in that the first module triggers the incrementing of the counter/down-counter by a recording value which corresponds to a predetermined duty cycle jump of the initial duty cycle, only if the said regulation loop does not have an acyclism.

The third module additionally preferably comprises means for comparison between the progressive charging return signal and the expected duty cycle at an instant of the charging requirement, for the purpose of determining the presence of the acyclism.

A computer memory which is provided in this system for controlling the progressive charging of an alternator of a motor vehicle highly advantageously comprises computer codes which are representative of the above-described method.

The invention also relates to an alternator of a motor vehicle comprising a system for controlling the progressive charging with the characteristics previously specified.

These few essential specifications will have made apparent to persons skilled in the art the advantages provided by the method for controlling the progressive charging of an alternator of a motor vehicle according to the invention, as well as by the control system and the corresponding alternator, in comparison with the prior art.

The detailed specifications of the invention are given in the following description in association with the appended drawings. It should be noted that these drawings serve the purpose only of illustrating the text of the description, and do not constitute in any way a limitation of the scope of the invention.

### BRIEF DESCRIPTION OF THE DRAWINGS

FIG. 1 is a synoptic diagram of the regulation loop of an alternator of a motor vehicle, of the type known in the prior art relating to the invention.

FIG. 2 is a synoptic diagram of a system for controlling the progressive charging of an alternator of a motor vehicle of the type according to the invention, known in the prior art.

FIG. 3 shows the fundamental parameters of an LRC function of the type known in the prior art relating to the invention.

FIG. 4 shows schematically the behaviour of an LRC function known in the prior art, in the case of the presence of an acyclism.

FIG. 5 is an algorithm of the LRC function in the method for controlling the progressive charging of an alternator of a motor vehicle according to the invention.

FIG. 6 shows schematically the behaviour of the LRC function in the method for controlling the progressive charging of an alternator of a motor vehicle according to the invention, in the case of the presence of an acyclism.

FIG. 7 shows schematically the behaviour of the LRC function in the method for controlling the progressive charging of an alternator of a motor vehicle according to the invention, in the case of the absence of an acyclism.

### DESCRIPTION OF THE PREFERRED EMBODIMENT OF THE INVENTION

As already stated in the preamble, methods and systems for controlling the progressive charging of an alternator of a motor vehicle of the type according to the invention which have the objective of improving the efficiency during idling are well known in the prior art.

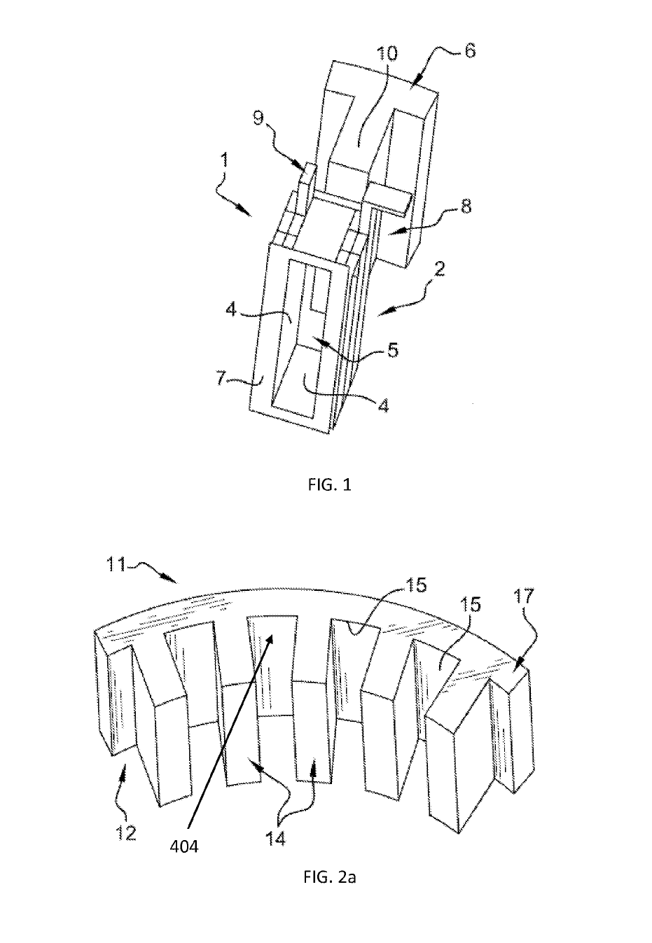

A general architecture of a supply by an alternator 1 of an on-board network 2 of a motor vehicle, to which there are connected a battery 3 and electric charges 4, is represented in FIG. 1.

The supply voltage Ubat tends to be kept constant, whilst being compared 5 continually with a set value Uref by a return supply 6.

According to the difference between the supply voltage Ubat and the set value Uref, an excitation signal 7 of the variable pulse width type DC_EXC which controls an excitation current I_EXC circulating in an excitation winding of the alternator 1 by means of a power switch 8 is controlled by the regulation loop 1, 5, 6, 8.

In nominal operation, the excitation signal 7 corresponds to the excitation demand signal 9 which is supplied by the regulation loop 1, 5, 6, 8, i.e. which is obtained from a comparator 5 between the supply voltage Ubat and the set value Uref.

In transitory operation, as the result of the connection of an electric charge 4 to the on-board network 2, the increase in a current duty cycle DC_EXC of the excitation signal 7 is limited by a progressive charging control system 10, and reaches only progressively an expected duty cycle DC_E of the excitation demand signal 9 calculated by the regulation loop 1, 5, 6, 8.

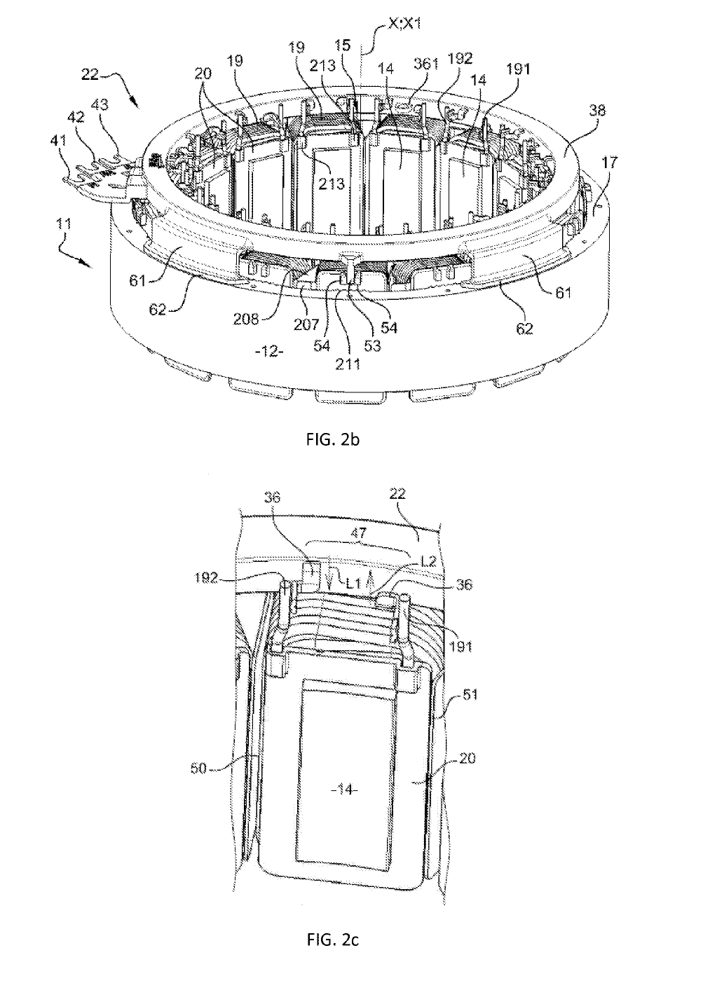

FIG. 2 shows the arrangement of a progressive charging control system 10 of the type according to the invention known in the prior art.

This system 10 comprises a numerical processing unit 11 comprising a first module 12 for detection of a charging requirement, a second module 13 for determination of an initial duty cycle DC_I, and a third module 14 for control of progressive charging, which supplies as output a progressive charging control duty cycle DC_LRC which increases progressively, starting from the initial duty cycle DC_I up to the expected duty cycle DC_E.

The system 10 also comprises a multiplexer 15 controlled by the third progressive charging control module 14, which supplies as output an excitation signal 7 with a current duty cycle DC_EXC which is equal either to the expected duty cycle DC_E or to the progressive charging control duty cycle DC_LRC supplied by the third module 14 in the case of detection of a charging requirement.

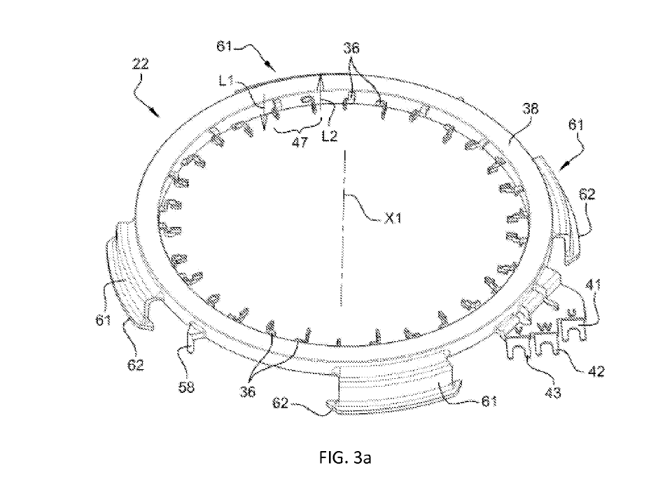

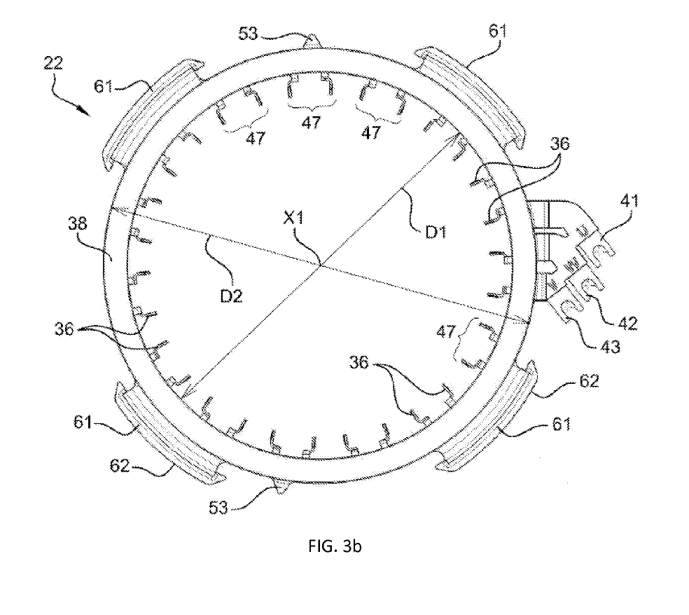

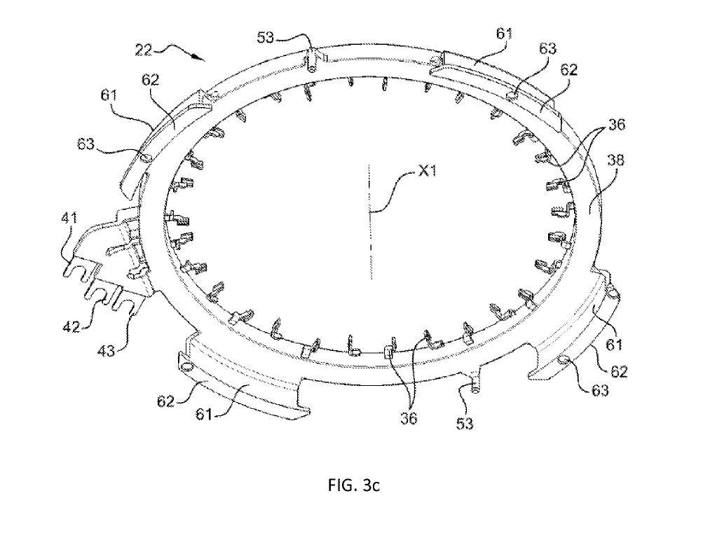

The LRC function is provided in a known manner by a counter/down-counter of the third module 14 which uses at least three parameters T_LRC, T_LRC_R, D_B which are well known to persons skilled in the art, and are indicated in the example of a charging requirement 16 represented in FIG. 3.

At the instant of the charging requirement 16, which for example changes the consumption on the on-board network 2 from 20 A to 50 A, there is a drop 17 in the supply voltage Ubat from a nominal voltage of 14 V to 13 V.

The excitation duty cycle DC_EXC which was stabilised at a constant value DC_I of 20% during a nominal phase N_R of the regulation must increase in order to reach an expected duty cycle DC_E which makes it possible to stabilise the supply voltage Ubat at the nominal value of 14 V with consumption of 50 A.

At the instant of the charging requirement 16, the LRC function is implemented in a progressive response phase LRC_Ph in order to limit the increase of the excitation duty cycle DC_EXC, by imposing a linear variation 18 during the predetermined rising time T_LRC. For this purpose, the current duty cycle DC_EXC is made to correspond with an index of the counter/down-counter, incremented by a clock signal.

Upon engagement of the LRC function, the excitation duty cycle DC_EXC is augmented 19 by the duty cycle jump D_B which is approximately 10%.

At the end of the progressive response phase LRC_Ph, during a progressive response return phase RCP_Ph, the excitation duty cycle DC_EXC is that which is calculated by the regulation loop 1, 5, 6, 8.

The counter/down-counter is decremented during the predetermined descent time T_LRC_R, and in this down-counter mode, its index corresponds to the progressive charging return signal RCP decreasing linearly 20.

These three parameters mostly form part of the specifications of the regulators established by the vehicle manufacturers.

They correspond to the standard control mode of the LRC function:
if a charging requirement 16 is detected, then the counter/down-counter is incremented by a recording value corresponding to the predetermined duty cycle jump D_B;
at the end of the progressive response phase LRC_Ph, the counter/down-counter is then decremented.

This standard control mode is a priori perfect: test bench tests show that the three fundamental parameters are clearly present on the time diagrams.

The inventive body has revealed unexpected behaviour of the of the LRC function implemented in this manner during tests on vehicles.

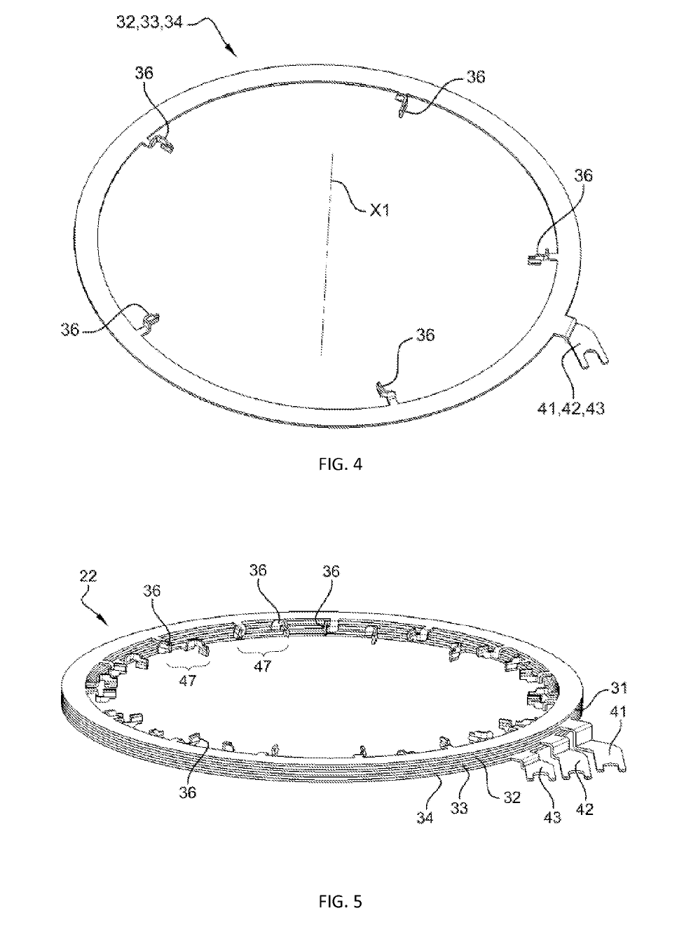

The functioning detected on vehicles is represented in FIG. 4.

The oscillations 21 caused by the acyclism trigger a succession of progressive response phases LRC_Ph beginning with a jump 19 of the current duty cycle DC_EXC by application of the predetermined duty cycle jump D_B.

This has the effect of bringing the counter/down-counter towards saturation, since the predetermined descent time T_LRC _R of the progressive charging return signal RCP is generally too long to permit significant decrementing 20 before the return of a new acyclism oscillation 21. In these circumstances, the LRC function thus becomes “almost without effect”.

The conclusion of this analysis formulated by the inventive body is an interpretation of the “duty cycle jump” parameter D_B: the duty cycle jump represents an area of immunity to the noise (jig derived from the regulation loop 1, 5, 6, 8) before triggering of the LRC function, and not an increment to be applied systematically at each new progressive response phase LRC_Ph.

The method for controlling the progressing charging of a motor vehicle alternator 1 according to the invention is based on specific control of the LRC function, described hereinafter in association with FIG. 5, which makes it possible to comply with the specifications of the vehicle manufacturers, i.e. to maintain the standard basic parameters T_LRC, T_LRC_R, D_B, whilst having efficient behaviour of the LRC function on the vehicle.

The parameters and variables which are taken into account by the algorithm represented in FIG. 5 are:
V1: predetermined starting speed;
V2: predetermined engine stoppage speed;
LD: predetermined triggering threshold of the LRC function in the counter/down-counter unit corresponding to a predetermined difference of expected duty cycles DC_E or to a drop in the supply voltage L_D;
FR: field required by the regulation loop 1, 5, 6, 8 in the counter/down-counter unit corresponding to the required duty cycle DC_E;
LRC: index of the counter/down-counter of the LRC function in counter mode, corresponding to the current duty cycle DC_EXC during the progressive response phase LRC_Ph;
RCP: index of the counter/down-counter of the LRC function in counter or down-counter mode corresponding to the signal of the progressive charging return signal RCP;
DB: value in the counter/down-counter unit of the predetermined duty cycle jump D_B.

These parameters and variables determine transitions between different modes of the LRC function:

MODE_INIT 22: This mode permits the pre-charging of the counter/down-counter at an initial index IV corresponding to a predetermined starting value INIT_VALUE of the initial duty cycle DC I.

The LRC function is triggered with this predetermined starting value INIT_VALUE when the speed of rotation of the alternator 1 is higher than the predetermined starting speed V1.

MODE_LRC 23: This mode engages the LRC function by making it possible to select the predetermined rising time T_LRC and to increment the index of the counter/down-counter.

The output of this progressive response phase LRC_Ph takes place after the predetermined rising time T_LRC and/or when the field required FR is lower than the LRC index.

MODE_RCP 24: This mode makes it possible to decrement the counter/down-counter, and to select the predetermined descent time T_LRC_R.

The output of this progressive response return phase RCP_Ph takes place after the predetermined descent time T_LRC_R and/or when the field required FR is higher than the index RCP.

MODE_TRACK_UP 25: This mode makes it possible to increment the counter/down-counter to the value of the field required FR by the regulation loop 1, 5, 6, 8, and to select the first predetermined continuation time T_TRACK_UP.

The output of this mode TRACK-UP 25 in a phase of alignment on the field required FR generally takes place towards a mode TRACK_DWN 26 after the first predetermined continuation time T_TRACK_UP if the field required FR is lower than the index RCP.

MODE_TRACK_DWN 26: This mode makes it possible to decrement the counter/down-counter to the value of the field required FR by the regulation loop, and to select the second predetermined continuation time T_TRACK_DWN.

The output of this mode TRACK_DWN 26 in a phase of alignment with the field required FR generally takes place towards a mode TRACK_UP 25 after the second predetermined continuation time T_TRACK_DWN, if the field required FR is higher than the index RCP.

In the case of detection of a charging requirement 16 which is higher than the predetermined triggering threshold LD of the LRC function, a transition of the modes TRACK_UP 25 and TRACK_DWN 26 is carried out towards a mode DEAD_BAND 27.

MODE_DEAD_BAND 27: This mode permits the addition of the value in the counter/down-counter unit DB of the predetermined duty cycle jump D_B to the counter/down-counter of the LRC function, in order to comply with the specifications of the vehicle manufacturers represented in FIG. 3, before another transition to the LRC mode 23.

The successions of the phases of progressive response LRC_Ph, progressive response return RCP_Ph and alignment A_Ph, optionally interrupted by transitions to the mode DEAD_BAND 27 in the case of a charging requirement 16, correspond to the normal functioning of the regulator, i.e. without the presence of an acyclism 21, 28, 29.

The presence of an acyclism 21, 28, 29 is detected when, during a progressive response return phase RCP_Ph (mode RCP 24), there is simultaneously a charging requirement 16 which is higher than the predetermined triggering threshold LD and a field required FR which is higher than the index RCP of the counter/down-counter.

In this case, there is direct transition from the mode RCP 24 to the mode LRC 23, without passage via the modes TRACK_UP 25 and TRACK_DWN 26, i.e. without passage via the mode DEAD_BAND 27.

In each of the modes LRC 23, RCP 24, TRACK_UP 25, TRACK_DWN 26 or DEAD_BAND 27, a return to the mode INIT 22 occurs when the speed of rotation of the alternator 1 becomes lower than the predetermined engine stoppage speed V2.

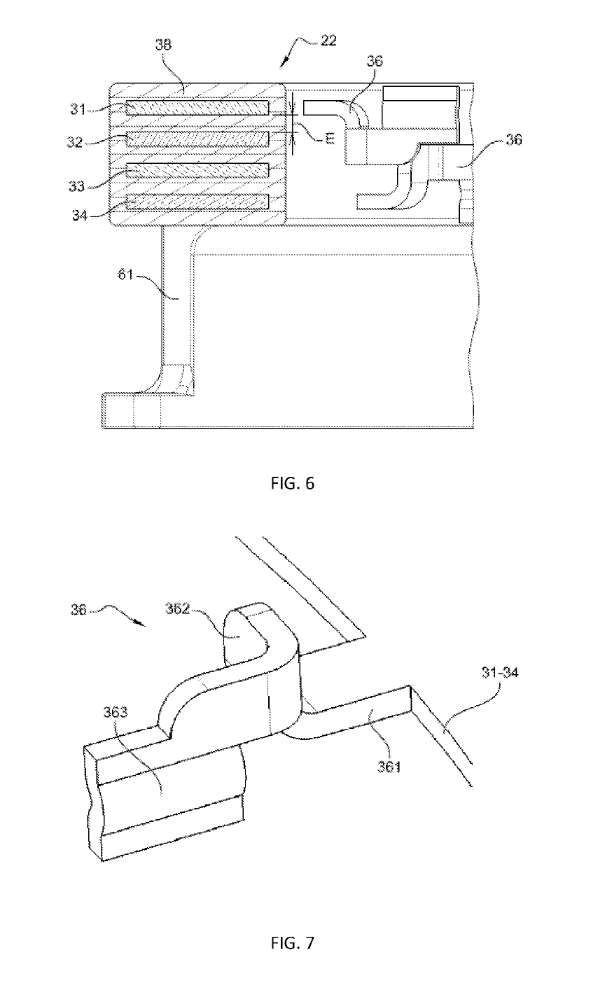

The result of implementation on a vehicle of the method according to the invention in the case of disrupted regulation is shown in FIG. 6.

After starting (mode INIT 22) and entry into an initial progressive response phase LRC_Ph₀ (mode LRC 23) with the predetermined starting value INIT_VALUE, a disruptive acyclism oscillation 28 then interrupts an initial progressive charging return phase RCP_Ph₀ (mode RCP 24), and triggers another progressive response phase LRC_Ph₁, without a predetermined duty cycle jump D_B according to the algorithm in FIG. 5.

The other disruptive oscillations 29 interrupt the successive progressive response LRC_Phₙ and progressive response return RCP_Phₙ phases during the duration of the acyclism T_A. The transitions to the mode LRC 23 are carried out without application of the predetermined duty cycle jump D_B.

The structure of the algorithm represented in FIG. 5, and in particular the conditions of transition to the mode DEAD_BAND 27, as well as the equality of the first and second continuation times T_TRACK_UP, T_TRACK_DWN in the modes TRACK_UP 25 and TRACK_DWN 26, thus make it possible to avoid the drift of the counter/down-counter of the LRC function.

As shown clearly in FIG. 6, a current initial duty cycle DC_Iₙ at the input of each progressive response phase LRC_Phₙ does not drift to high full field values as shown in FIG. 4, in the case of the presence of an acyclism 21, 28, 29.

On the contrary, at the end of the duration of the acyclism T_A in the mode LRC 23, the initial duty cycle DC_I is reset substantially to a mean value M_A of this acyclism 21, 28, 29.

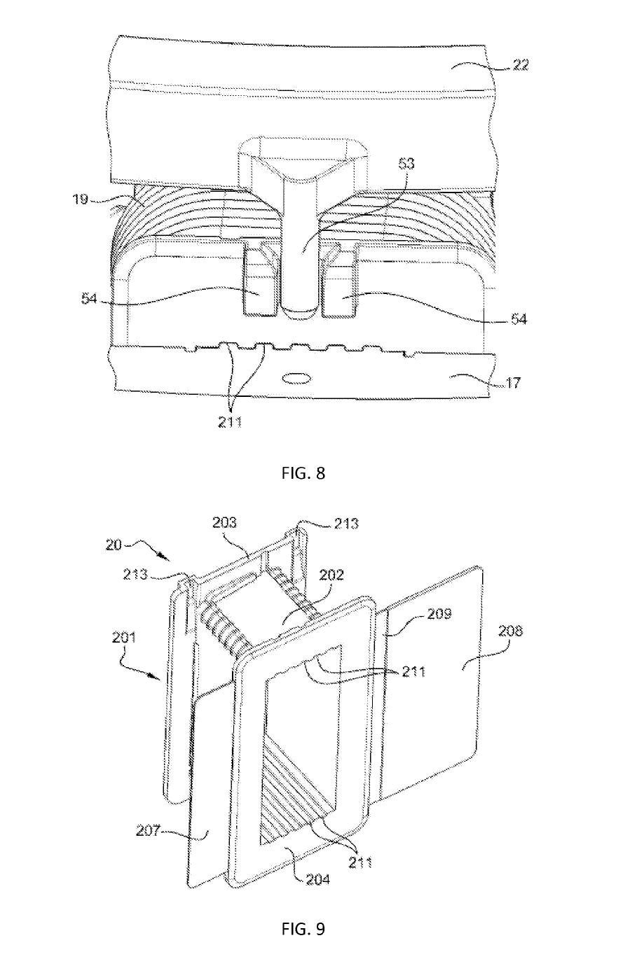

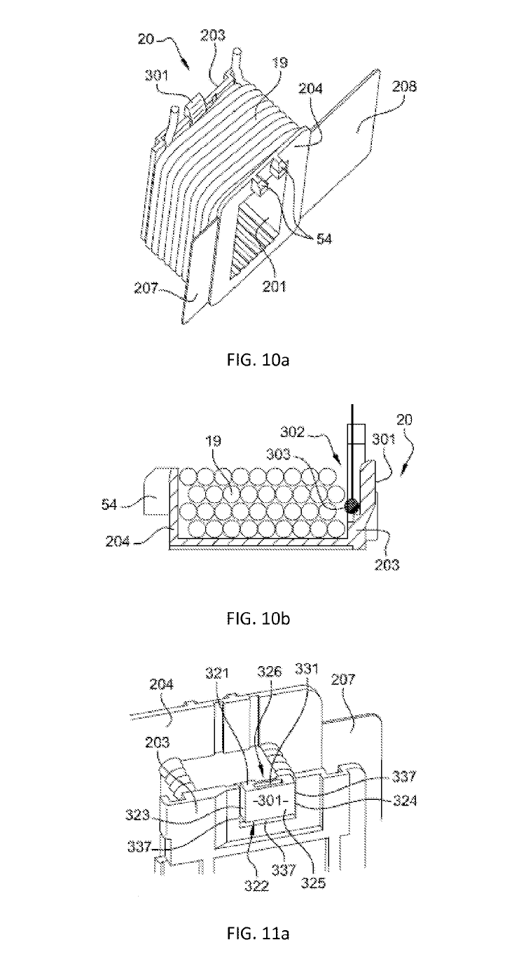

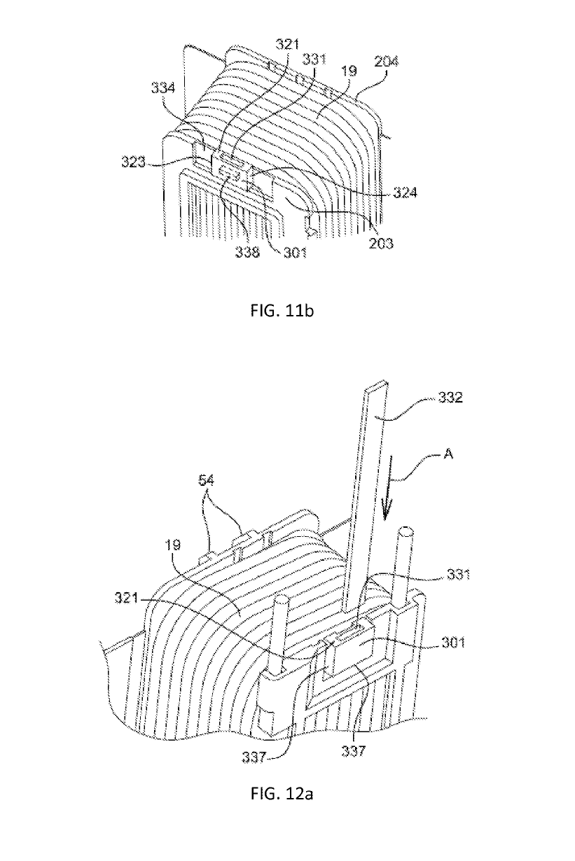

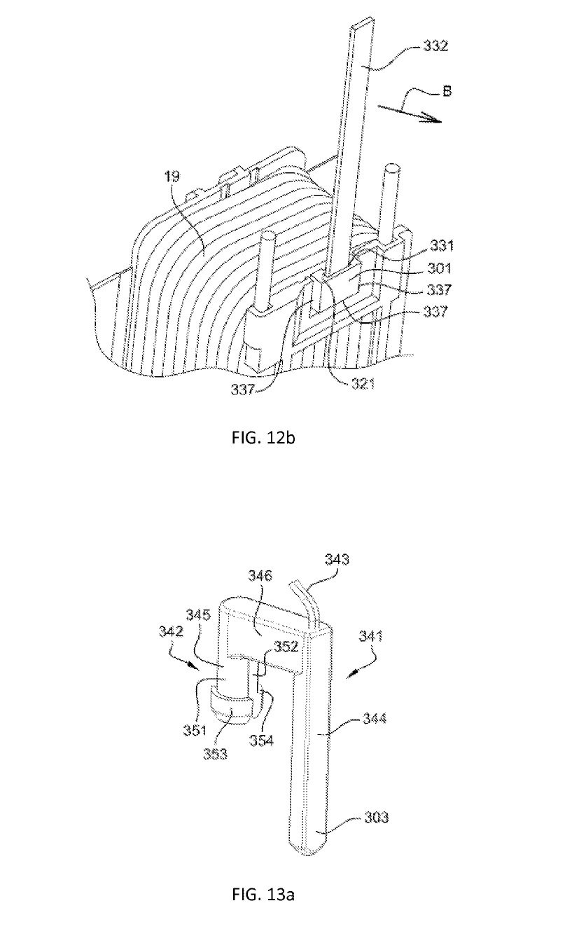

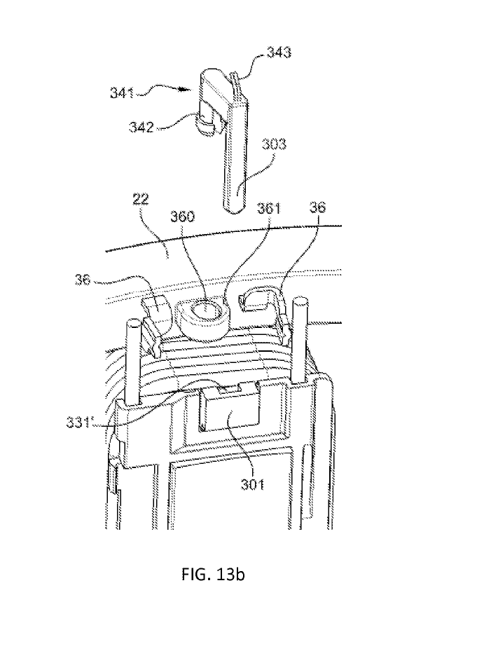

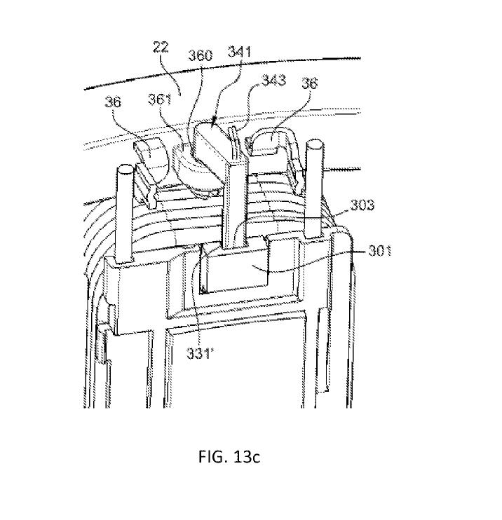

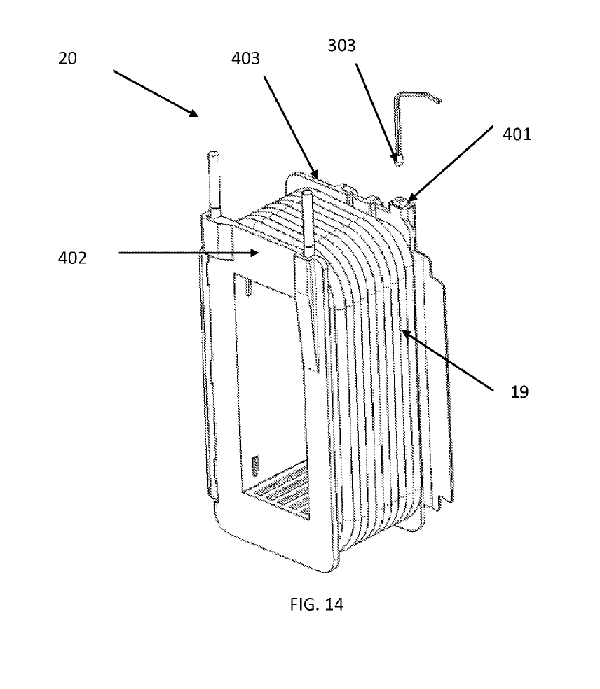

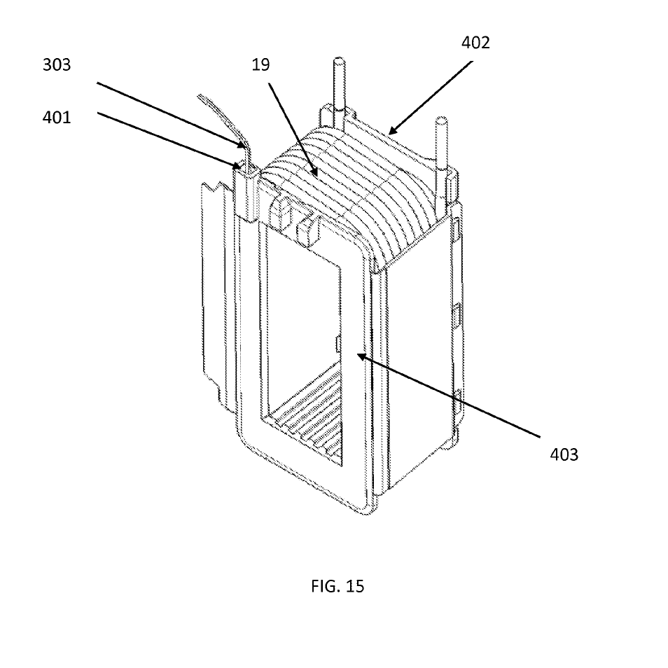

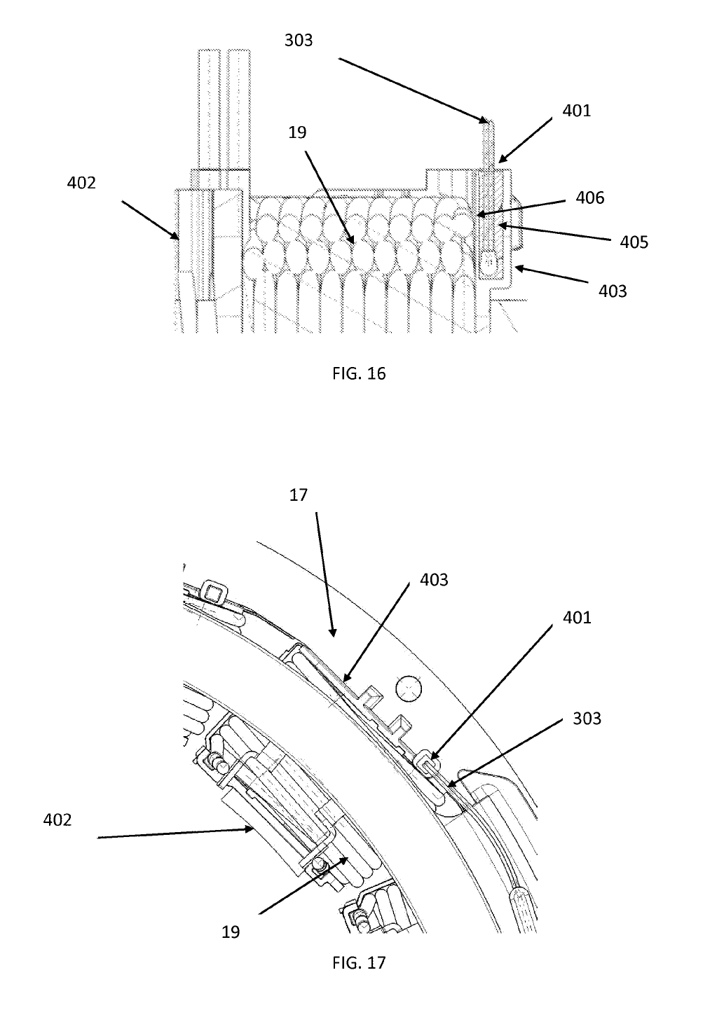

In the absence of an acyclism 21, 28, 29, the method for controlling the progressive charging of an alternator 1 of a motor vehicle according to the invention leads to an LRC function in conformity with the standard established by the vehicle manufacturers, as shown by comparison of FIG. 3, which indicates the basic parameters of this function, and FIG. 7 which shows the result of implementation of this method on a vehicle.

After the starting (mode INIT 22) and entry into the initial progressive response phase LRC_Ph₀ (mode LRC 23), with the predetermined starting value INIT_VALUE, the initial progressive charging return phase RCP_Ph₀ (mode RCP 24) is followed by an alignment phase A_Ph which makes it possible to align the progressive charging return signal RCP 30, 31 with the expected duty cycle DC_E, in conformity with the algorithm in FIG. 5 (modes TRACK_UP 25 and TRACK_DWN 26).

FIG. 7 shows clearly, in the case of a charging requirement 16 after a period of stability T_S of the regulation, the triggering of a standard progressive response phase LRC_Phₛ (mode LRC 23) with application of the predetermined duty cycle jump D_B (previous transition via the mode DEAD_BAND 27).

Preferably, the algorithm represented in FIG. 5 is executed by a microprocessor or microcontrollers which is already present in the numerical processing unit 11 of the progressive charging control system 10.

A computer memory comprises computer codes which are representative of the method according to the invention, with replacement of the instructions corresponding to the standard LRC function.

Since various tests carried out on vehicles have confirmed the advantages provided by the above-described non-standard control of the LRC function, which eliminates the disadvantages of the known progressive charging control systems, the industrial deployment of this control on mass-produced alternators is particularly easy, since it is sufficient to proceed with simple updating of software. This deployment facility is an additional competitive advantage in comparison with other technical solutions which would give rise in particular to mechanical modifications.

It will be appreciated that the invention is not limited simply to the above-described preferred embodiment.

In particular, equivalent architectures of the algorithm of the LRC function described above in association with FIG. 5, and alternative choices of variables of decisions or parameters leading to the same timing diagrams as those represented in FIGS. 6 and 7, would simply constitute variant embodiments.

These variant embodiments would not depart from the context of the present invention, provided that they are derived from the following claims.

1. Method for controlling the progressive charging of an alternator (1) of a motor vehicle which is designed to be coupled to a thermal engine of said vehicle and can produce a supply voltage (Ubat) of an on-board network (2) of the said vehicle which depends on a set value (Uref), by means of a regulation loop (1, 5, 6, 8) which controls an excitation signal (7) of the variable pulse width type (DC_EXC), which controls an excitation current (I_EXC) circulating in an excitation winding of said alternator (1), said method being of the type which consists of limiting collection of torque by said alternator (1) from the thermal engine in a phase of progressive response (LRC_Ph) to a drop (17) of said supply voltage (Ubat) which is greater than a predetermined triggering threshold (L_D), whilst permitting only progressive increases of a current duty cycle (DC_EXC) of said excitation signal (7), from an initial duty cycle (DC_I) up to an expected duty cycle (DC_E) calculated by the said regulation loop (1, 5, 6, 8), wherein, at the beginning of said progressive response phase (LRC_Ph), said initial duty cycle (DC_I) is increased by a predetermined jump (D_B) only if said regulation loop (1, 5, 6, 8) does not have an acyclism (21, 28, 29).

2. Method for controlling the progressive charging of an alternator (1) of a motor vehicle according to claim 1, characterized in that said initial duty cycle (DC-I) does not drift towards a full field in the case of the said acyclism (21, 28, 29), and in that said initial duty cycle (DC-I) is reset at the end of said acyclism (21, 28, 29) substantially to a mean value (M_A) of the said acyclism (21, 28, 29).

3. Method for controlling the progressive charging of an alternator (1) of a motor vehicle according to claim 1, characterized in that, during said progressive response phase (LRC_Ph), said current duty cycle (DC_EXC) is equal to a progressive charging control duty cycle (DC_LRC) which increases linearly (18) during at the most a predetermined rising time (T_LRC), and in that, at the end of said progressive response phase (LRC_Ph), said current duty cycle (DC_EXC) is equal to said expected duty cycle (DC_E), and a progressive charging return signal (RCP) which controls said initial duty cycle (DC_I) decreases linearly (20) during at most a predetermined descent time (T_LRC_R), during a progressive response return phase (RCP_Ph).

4. Method for controlling the progressive charging of an alternator (1) of a motor vehicle according to claim 3, characterized in that a presence of said acyclism (21, 28, 29) is determined by simultaneous creation of the following conditions in said progressive response return phase (RCP_Ph):
said supply voltage (Ubat) drop (17) is greater than said predetermined triggering threshold (L_D);
the expected duty cycle (DC_E) is greater than said progressive charging return signal (RCP).

5. Method for controlling the progressive charging of an alternator (1) of a motor vehicle according to claim 4, characterized in that, at the end of said progressive response return phase (RCP_Ph), during a phase of alignment (A_Ph) with said expected duty cycle (DC_E), the said progressive charging return signal (RCP) increases linearly (30) during a first continuation time (T_TRACK_UP), or it decreases linearly (31) during a second continuation time (T_TRACK_DWN).

6. Method for controlling the progressive charging of an alternator (1) of a motor vehicle according to claim 5, characterized in that the said first and second continuation times (T_TRACK_UP, T_TRACK_DWN) are equal.

7. Method for controlling the progressive charging of an alternator (1) of a motor vehicle according to claim 1, characterized in that said initial duty cycle (DC_I) is reset to a predetermined starting value (INIT_VALUE) when a speed of rotation of said alternator (1) becomes higher than a predetermined starting speed (V1) starting from a stoppage.

8. System for controlling the progressive charging (10) of an alternator (1) of a motor vehicle which can implement the method according to claim 1, said alternator (1) being designed to be coupled to a thermal engine of said vehicle, and comprising a regulation loop (1, 5, 6, 8) which subjects a supply voltage (Ubat) of an on-board network (2) of said vehicle to a set value (Uref) by controlling an excitation signal (7) of the variable pulse width type (DC_EXC), which controls an excitation current (I_EXC) circulating in an excitation winding of said alternator (1), said system being of the type comprising a numerical processing unit (11), comprising a first module (12) for detection of a charging requirement (16) starting from an expected duty cycle (DC_E), a second module (13) for determination of an initial duty cycle (DC_I), and a third module (14) for controlling the progressive charging comprising a counter/down-counter which provides an index corresponding either to a progressive charging control duty cycle (DC_LRC) which increases progressively starting from said initial duty cycle (DC_I), or to a progressive charging return signal (RCP), characterized in that the said first module (12) triggers the incrementing of said counter/down-counter by a recording value (DB) which corresponds to a predetermined duty cycle jump (D_B) of said initial duty cycle (DC_I), only if said regulation loop (1, 5, 6, 8) does not have an acyclism (21, 28, 29).

9. System for controlling the progressive charging (10) of an alternator (1) of a motor vehicle according to claim 8, characterized in that said third module (14) additionally comprises means for comparison between said progressive charging return signal (RCP) and said expected duty cycle (DC_E) at an instant of said charging requirement (16), for the purpose of determining the presence of said acyclism (21, 28, 29).

10. Computer memory which is provided in the system for controlling the progressive charging (10) of an alternator (1) of a motor vehicle according to claim 8, comprising computer codes which are representative of the method for controlling the progressive charging of an alternator (1) of a motor vehicle.

11. Alternator (1) of a motor vehicle characterized in that it comprises a system for controlling the progressive charging (10) according to claim 8.

12. Method for controlling the progressive charging of an alternator (1) of a motor vehicle according to claim 2, characterized in that, during said progressive response phase (LRC_Ph), said current duty cycle (DC_EXC) is equal to a progressive charging control duty cycle (DC_LRC) which increases linearly (18) during at the most a predetermined rising time (T_LRC), and in that, at the end of said progressive response phase (LRC_Ph), said current duty cycle (DC_EXC) is equal to said expected duty cycle (DC_E), and a progressive charging return signal (RCP) which controls said initial duty cycle (DC_I) decreases linearly (20) during at most a predetermined descent time (T_LRC_R), during a progressive response return phase (RCP_Ph).

13. Method for controlling the progressive charging of an alternator (1) of a motor vehicle according to claim 2, characterized in that said initial duty cycle (DC_I) is reset to a predetermined starting value (INIT_VALUE) when a speed of rotation of said alternator (1) becomes higher than a predetermined starting speed (V1) starting from a stoppage.

14. Method for controlling the progressive charging of an alternator (1) of a motor vehicle according to claim 3, characterized in that said initial duty cycle (DC_I) is reset to a predetermined starting value (INIT_VALUE) when a speed of rotation of said alternator (1) becomes higher than a predetermined starting speed (V1) starting from a stoppage.

15. Method for controlling the progressive charging of an alternator (1) of a motor vehicle according to claim 4, characterized in that said initial duty cycle (DC_I) is reset to a predetermined starting value (INIT_VALUE) when a speed of rotation of said alternator (1) becomes higher than a predetermined starting speed (V1) starting from a stoppage.

16. Method for controlling the progressive charging of an alternator (1) of a motor vehicle according to claim 5, characterized in that said initial duty cycle (DC_I) is reset to a predetermined starting value (INIT_VALUE) when a speed of rotation of said alternator (1) becomes higher than a predetermined starting speed (V1) starting from a stoppage.

17. Method for controlling the progressive charging of an alternator (1) of a motor vehicle according to claim 6, characterized in that said initial duty cycle (DC_I) is reset to a predetermined starting value (INIT_VALUE) when a speed of rotation of said alternator (1) becomes higher than a predetermined starting speed (V1) starting from a stoppage.

18. System for controlling the progressive charging (10) of an alternator (1) of a motor vehicle which can implement the method according to claim 2, said alternator (1) being designed to be coupled to a thermal engine of said vehicle, and comprising a regulation loop (1, 5, 6, 8) which subjects a supply voltage (Ubat) of an on-board network (2) of said vehicle to a set value (Uref) by controlling an excitation signal (7) of the variable pulse width type (DC_EXC), which controls an excitation current (I_EXC) circulating in an excitation winding of said alternator (1), said system being of the type comprising a numerical processing unit (11), comprising a first module (12) for detection of a charging requirement (16) starting from an expected duty cycle (DC_E), a second module (13) for determination of an initial duty cycle (DC_I), and a third module (14) for controlling the progressive charging comprising a counter/down-counter which provides an index corresponding either to a progressive charging control duty cycle (DC_LRC) which increases progressively starting from said initial duty cycle (DC_I), or to a progressive charging return signal (RCP), characterized in that said first module (12) triggers the incrementing of said counter/down-counter by a recording value (DB) which corresponds to a predetermined duty cycle jump (D_B) of said initial duty cycle (DC_I), only if said regulation loop (1, 5, 6, 8) does not have an acyclism (21, 28, 29).

19. System for controlling the progressive charging (10) of an alternator (1) of a motor vehicle which can implement the method according to claim 3, said alternator (1) being designed to be coupled to a thermal engine of said vehicle, and comprising a regulation loop (1, 5, 6, 8) which subjects a supply voltage (Ubat) of an on-board network (2) of said vehicle to a set value (Uref) by controlling an excitation signal (7) of the variable pulse width type (DC_EXC), which controls an excitation current (I_EXC) circulating in an excitation winding of said alternator (1), said system being of the type comprising a numerical processing unit (11), comprising a first module (12) for detection of a charging requirement (16) starting from an expected duty cycle (DC_E), a second module (13) for determination of an initial duty cycle (DC_I), and a third module (14) for controlling the progressive charging comprising a counter/down-counter which provides an index corresponding either to a progressive charging control duty cycle (DC_LRC) which increases progressively starting from said initial duty cycle (DC_I), or to a progressive charging return signal (RCP), characterized in that said first module (12) triggers the incrementing of said counter/down-counter by a recording value (DB) which corresponds to a predetermined duty cycle jump (D_B) of said initial duty cycle (DC_I), only if said regulation loop (1, 5, 6, 8) does not have an acyclism (21, 28, 29).

20. System for controlling the progressive charging (10) of an alternator (1) of a motor vehicle which can implement the method according to claim 4, said alternator (1) being designed to be coupled to a thermal engine of said vehicle, and comprising a regulation loop (1, 5, 6, 8) which subjects a supply voltage (Ubat) of an on-board network (2) of said vehicle to a set value (Uref) by controlling an excitation signal (7) of the variable pulse width type (DC_EXC), which controls an excitation current (I_EXC) circulating in an excitation winding of said alternator (1), said system being of the type comprising a numerical processing unit (11), comprising a first module (12) for detection of a charging requirement (16) starting from an expected duty cycle (DC_E), a second module (13) for determination of an initial duty cycle (DC_I), and a third module (14) for controlling the progressive charging comprising a counter/down-counter which provides an index corresponding either to a progressive charging control duty cycle (DC_LRC) which increases progressively starting from said initial duty cycle (DC_I), or to a progressive charging return signal (RCP), characterized in that said first module (12) triggers the incrementing of said counter/down-counter by a recording value (DB) which corresponds to a predetermined duty cycle jump (D_B) of said initial duty cycle (DC_I), only if said regulation loop (1, 5, 6, 8) does not have an acyclism (21, 28, 29).

21. System for controlling the progressive charging (10) of an alternator (1) of a motor vehicle which can implement the method according to claim 5, said alternator (1) being designed to be coupled to a thermal engine of said vehicle, and comprising a regulation loop (1, 5, 6, 8) which subjects a supply voltage (Ubat) of an on-board network (2) of said vehicle to a set value (Uref) by controlling an excitation signal (7) of the variable pulse width type (DC_EXC), which controls an excitation current (I_EXC) circulating in an excitation winding of said alternator (1), said system being of the type comprising a numerical processing unit (11), comprising a first module (12) for detection of a charging requirement (16) starting from an expected duty cycle (DC_E), a second module (13) for determination of an initial duty cycle (DC_I), and a third module (14) for controlling the progressive charging comprising a counter/down-counter which provides an index corresponding either to a progressive charging control duty cycle (DC_LRC) which increases progressively starting from said initial duty cycle (DC_I), or to a progressive charging return signal (RCP), characterized in that said first module (12) triggers the incrementing of said counter/down-counter by a recording value (DB) which corresponds to a predetermined duty cycle jump (D_B) of said initial duty cycle (DC_I), only if said regulation loop (1, 5, 6, 8) does not have an acyclism (21, 28, 29).

22. System for controlling the progressive charging (10) of an alternator (1) of a motor vehicle which can implement the method according to claim 6, said alternator (1) being designed to be coupled to a thermal engine of said vehicle, and comprising a regulation loop (1, 5, 6, 8) which subjects a supply voltage (Ubat) of an on-board network (2) of said vehicle to a set value (Uref) by controlling an excitation signal (7) of the variable pulse width type (DC_EXC), which controls an excitation current (I_EXC) circulating in an excitation winding of said alternator (1), said system being of the type comprising a numerical processing unit (11), comprising a first module (12) for detection of a charging requirement (16) starting from an expected duty cycle (DC_E), a second module (13) for determination of an initial duty cycle (DC_I), and a third module (14) for controlling the progressive charging comprising a counter/down-counter which provides an index corresponding either to a progressive charging control duty cycle (DC_LRC) which increases progressively starting from said initial duty cycle (DC_I), or to a progressive charging return signal (RCP), characterized in that said first module (12) triggers the incrementing of said counter/down-counter by a recording value (DB) which corresponds to a predetermined duty cycle jump (D_B) of said initial duty cycle (DC_I), only if said regulation loop (1, 5, 6, 8) does not have an acyclism (21, 28, 29).

23. System for controlling the progressive charging (10) of an alternator (1) of a motor vehicle which can implement the method according to claim 7, said alternator (1) being designed to be coupled to a thermal engine of said vehicle, and comprising a regulation loop (1, 5, 6, 8) which subjects a supply voltage (Ubat) of an on-board network (2) of said vehicle to a set value (Uref) by controlling an excitation signal (7) of the /variable pulse width type (DC_EXC), which controls an excitation current (I_EXC) circulating in an excitation winding of said alternator (1), said system being of the type comprising a numerical processing unit (11), comprising a first module (12) for detection of a charging requirement (16) starting from an expected duty cycle (DC_E), a second module (13) for determination of an initial duty cycle (DC_I), and a third module (14) for controlling the progressive charging comprising a counter/down-counter which provides an index corresponding either to a progressive charging control duty cycle (DC_LRC) which increases progressively starting from said initial duty cycle (DC_I), or to a progressive charging return signal (RCP), characterized in that said first module (12) triggers the incrementing of said counter/down-counter by a recording value (DB) which corresponds to a predetermined duty cycle jump (D_B) of said initial duty cycle (DC_I), only if said regulation loop (1, 5, 6, 8) does not have an acyclism (21, 28, 29).
